(19) United States
(12) Patent Application Publication
(10) Pub. No.: US 2026/0132755 A1
(43) Pub. Date: May 14, 2026

(54) DUAL FUEL INJECTION SYSTEM CONTROL

(71) Applicant: GM Global Technology Operations LLC, Detroit, MI (US)

(72) Inventors: J. Michael Gwidt, Brighton, MI (US); Haresh Dayaljee Varu, Novi, MI (US); Chinmay Avachat, Rochester Hills, MI (US); Jonathan Ashton Law, Fenton, MI (US); Daniel P. Himes, Detroit, MI (US)

(21) Appl. No.: 18/944,360

(22) Filed: Nov. 12, 2024

(51) Int. Cl. F02D 41/40; F02D 41/00; F02D 41/38

(52) U.S. Cl. CPC F02D 41/402; F02D 41/0002; F02D 2041/389; F02D 2200/06

(57) ABSTRACT

A system for fuel injection includes a primary fuel injection system configured to inject a fuel into a cylinder of a combustion engine using a first injection technique, and a supplemental fuel injection system configured to inject the fuel into the cylinder according a second injection technique, the second injection technique being different than the first injection technique. The system also includes a controller configured to monitor a parameter of a fuel pump connected to the primary fuel injection system and the supplemental fuel injection system, and based on the parameter being greater than or equal to a parameter threshold, control a ratio of a first volume of fuel injected by the supplemental fuel injection system to a second volume of fuel injected by the primary fuel injection system during an engine stroke.

### INTRODUCTION

The subject disclosure relates to the art of engine systems and, more particularly, to fuel injection in engine systems.

A fuel injection system injects fuel into an engine using fuel injectors. Fuel injection is typically controlled by an engine control module (ECM) or other controller. A vehicle may include one or more of various types of fuel injectors, such as port fuel injectors and/or direct fuel injectors. During vehicle operation, it is important to keep fuel injection parameters, such as flow rate and injection volume, to within capabilities of vehicle hardware, including fuel pumps.

### SUMMARY

In one exemplary embodiment, a system for fuel injection includes a primary fuel injection system configured to inject a fuel into a cylinder of a combustion engine using a first injection technique, and a supplemental fuel injection system configured to inject the fuel into the cylinder according a second injection technique, the second injection technique being different than the first injection technique. The system also includes a controller configured to monitor a parameter of a fuel pump connected to the primary fuel injection system and the supplemental fuel injection system, and based on the parameter being greater than or equal to a parameter threshold, control a ratio of a first volume of fuel injected by the supplemental fuel injection system to a second volume of fuel injected by the primary fuel injection system during an engine stroke.

In addition to one or more of the features described herein, the primary fuel injection system includes a direct injector having a first size, and the supplemental fuel injection system includes a direct injector having a second size, the second size being different than the first size.

In addition to one or more of the features described herein, the primary fuel injection system is a direct injection system, and the supplemental fuel injection system is a port fuel injection system.

In addition to one or more of the features described herein, the parameter is a fuel intake volume related to an amount of the fuel that the fuel pump takes in.

In addition to one or more of the features described herein, the parameter is an average volume of fuel intake to the fuel pump over a plurality of engine strokes.

In addition to one or more of the features described herein, the controller is configured to operate the combustion engine according to a normal mode in which fuel injection is performed using a first value of the ratio, and operate the combustion engine according to a supplemental mode in which fuel injection is performed using a second value of the ratio, the second value of the ratio selected to cause the parameter to fall below the parameter threshold.

In addition to one or more of the features described herein, the fuel injection is performed only by the primary fuel injection system in the normal mode, and the fuel injection is performed only by the supplemental fuel injection system or by a combination of the primary fuel injection system and the supplemental fuel injection system in the supplemental mode.

In addition to one or more of the features described herein, the controller is configured to determine the parameter during the supplemental mode, and compare the determined parameter to the parameter threshold.

In addition to one or more of the features described herein, the controller is configured to adjust a flow of air to the cylinder based on the determined parameter being greater than or equal to the parameter threshold during the supplemental mode.

In another exemplary embodiment, a method of operating a combustion engine includes providing a fuel-air mixture to the combustion engine by injecting a fuel into a cylinder of the combustion engine, the injecting performed by at least one of a primary fuel injection system configured to inject the fuel using a first injection technique, and a supplemental fuel injection system configured to inject the fuel using a second injection technique, the second injection technique being different than the first injection technique. The method also includes monitoring a parameter of a fuel pump connected to the primary fuel injection system and the supplemental fuel injection system, and based on the parameter being greater than or equal to a parameter threshold, controlling a ratio of a first volume of the fuel injected by the supplemental fuel injection system to a second volume of the fuel injected by the primary fuel injection system during an engine stroke.

In addition to one or more of the features described herein, the primary fuel injection system includes a direct injector having a first size, and the supplemental fuel injection system includes a direct injector having a second size, the second size different than the first size.

In addition to one or more of the features described herein, the primary fuel injection system is a direct injection system, and the supplemental fuel injection system is a port fuel injection system.

In addition to one or more of the features described herein, the parameter is a fuel intake volume related to an amount of the fuel that the fuel pump takes in.

In addition to one or more of the features described herein, the combustion engine is operated according to a normal mode in which fuel injection is performed using a first value of the ratio, and the combustion engine is operated according to a supplemental mode in which fuel injection is performed according to a second value of the ratio, the second value of the ratio selected to cause the parameter to fall below the parameter threshold.

In addition to one or more of the features described herein, the fuel injection is performed only by the primary fuel injection system in the normal mode, and the fuel injection is performed only by the supplemental fuel injection system or by a combination of the primary fuel injection system and the supplemental fuel injection system in the supplemental mode.

In addition to one or more of the features described herein, the method further includes determining the parameter during the supplemental mode, comparing the determined parameter to the parameter threshold, and adjusting a flow of air to the cylinder based on the determined parameter being greater than or equal to the parameter threshold.

In yet another exemplary embodiment, a vehicle system includes a combustion engine, and a fuel system including a primary fuel injection system configured to inject a fuel into a cylinder of the combustion engine using a first injection technique, and a supplemental fuel injection system configured to inject the fuel into the cylinder using a second injection technique, the second injection technique being different than the first injection technique. The vehicle system also includes a controller configured to monitor a parameter of a fuel pump connected to the primary fuel injection system and the supplemental fuel injection system, and based on the parameter being greater than or equal to a parameter threshold, control a ratio of a first volume of the fuel injected by the supplemental fuel injection system to a second volume of the fuel injected by the primary fuel injection system during an engine stroke.

In addition to one or more of the features described herein, the controller is configured to operate the combustion engine according to a normal mode in which fuel injection is performed using a first value of the ratio, and operate the combustion engine according to a supplemental mode in which fuel injection is performed using a second value of the ratio, the second value of the ratio selected to cause the parameter to fall below the parameter threshold.

In addition to one or more of the features described herein, the fuel injection is performed only by the primary fuel injection system in the normal mode, and the fuel injection is performed only by the supplemental fuel injection system or by a combination of the primary fuel injection system and the supplemental fuel injection system in the supplemental mode.

In addition to one or more of the features described herein, the controller is configured to determine the parameter during the supplemental mode, compare the determined parameter to the parameter threshold, and adjust a flow of air to the cylinder based on the determined parameter being greater than or equal to the parameter threshold.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top schematic view of a vehicle, in accordance with an exemplary embodiment;

FIG. 2 is a cross-sectional view of an engine including a fuel injection system, in accordance with an exemplary embodiment;

FIG. 3 is a flow diagram depicting aspects of a method of controlling a combustion engine, in accordance with an exemplary embodiment; and

FIG. 4 depicts a computer system, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with exemplary embodiments, a fuel injection system for a combustion engine and associated methods are provided. An embodiment of a propulsion system includes a primary fuel injection system and a supplemental fuel injection system. A controller is configured to monitor a component or components of the propulsion system, such as a fuel pump, and compare a parameter related to fuel injection and/or propulsion (e.g., pump intake volume) to a parameter threshold (e.g., a maximum pump capacity or maximum intake volume).

Based on the parameter being greater than or equal to the parameter threshold, the controller transitions the engine from a normal mode to a supplemental mode. In the normal mode, fuel injection is exclusively provided by the primary fuel injection system, or fuel is injected using an initial ratio of supplemental fuel injection to primary fuel injection. In the supplemental mode, the controller activates the supplemental fuel injection system and/or adjusts the ratio so that fuel injection can continue without exceeding the capability of a fuel pump and/or other component(s).

Embodiments described herein present numerous advantages and technical effects. The embodiments provide for improvements in efficiency and performance of combustion engines. For example, the embodiments ensure that sufficient fuel is supplied under any condition, while ensuring that fuel system components such as high pressure fuel pumps stay within operating limits. In addition, embodiments allow for fuel systems that are under-sized for all environmental conditions (e.g., allow for smaller size fuel pumps as compared to existing fuel injection systems). By allowing an under-sized fuel system, emissions are improved and resources needed to construct a fuel system and cam shaft assembly are reduced.

The embodiments are not limited to use with any specific vehicle and may be applicable to various contexts. For example, embodiments may be used with automobiles, trucks, construction equipment, power tools, motorcycles, boats, aircraft, and/or any other device or system that includes a fuel-injected engine or engines.

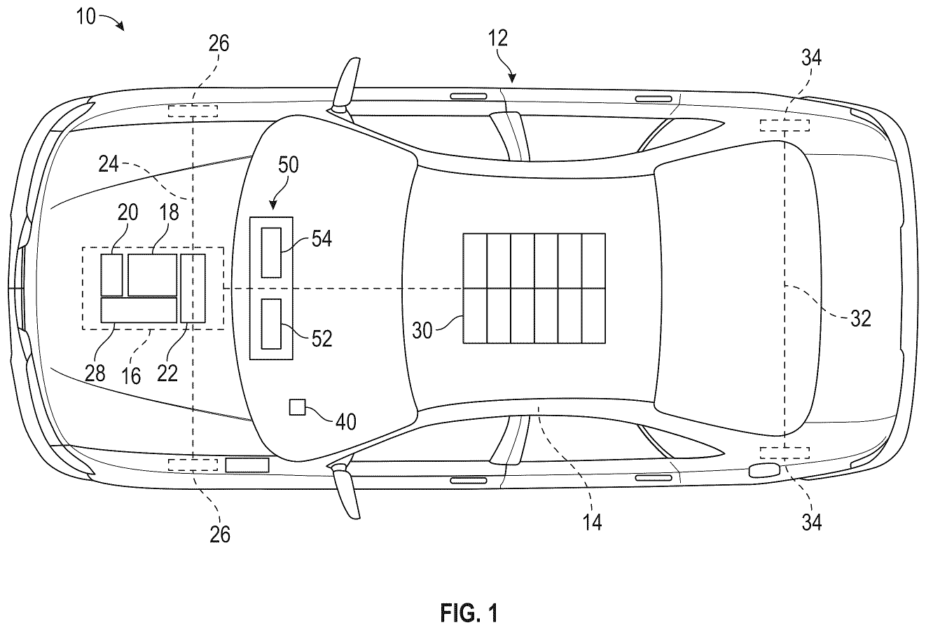

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem and others. If the vehicle 10 is a combustion vehicle or a hybrid electric vehicle, other vehicle components include a fuel injection subsystem, an exhaust subsystem and others.

For example, the vehicle 10 is a hybrid vehicle, in which the propulsion system 16 includes a combustion engine 18 for applying torque, and other components for supporting engine operation, such as a cooling system 20. The engine 18 is connected to a transmission system 22 for controlling the transfer of torque from the engine 18 to a front drive shaft 24 connected to front wheels 26. The propulsion system 16 may also include an electric drive system including at least one electric motor 28 connected to a high voltage (HV) battery pack 30.

The propulsion system 16 is not limited to the configuration shown in FIG. 1, as there may be any number of propulsion devices. For example, the vehicle 10 can include a motor and/or combustion engine (in addition to or in place of the engine 18 and the motor 28) connected to a rear drive shaft 32 and rear wheels 34.

One or more processing devices are included to control operation of the propulsion system 16. In an embodiment, a controller 40, such as an engine control unit (ECU), is configured to receive torque requests and control the engine 18.

The vehicle 10 also includes a computer system 50 that includes one or more processing devices 52 and a user interface 54. The computer system 50 may communicate with the controller 40 (e.g., ECU) and/or other processor(s), for example, to provide commands thereto in response to a user input (e.g., torque commands). The various processing devices, modules and units may communicate with one another via a communication device or system, such as a controller area network (CAN) or transmission control protocol (TCP) bus.

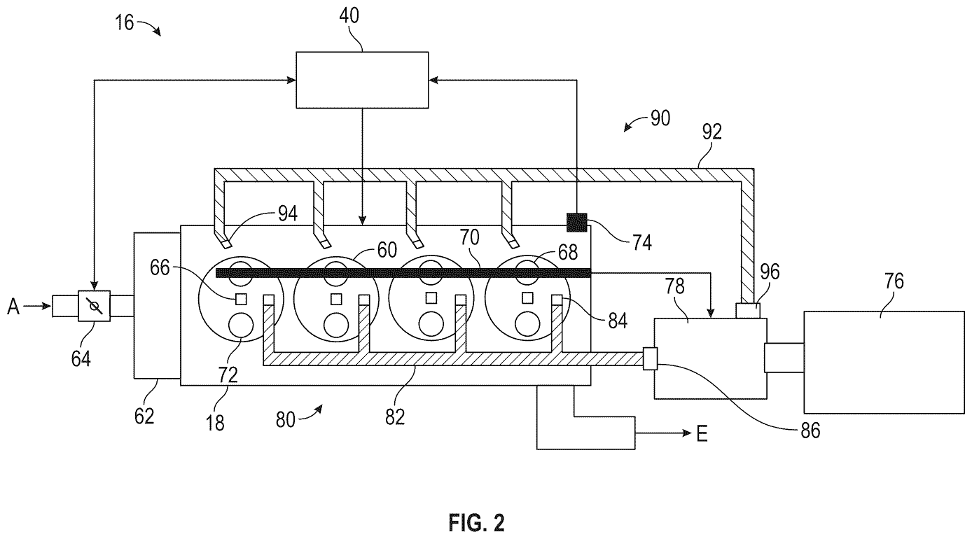

FIG. 2 depicts an embodiment of the propulsion system 16. In this embodiment, the propulsion system 16 includes a fuel injection system that has a primary injection system and a secondary or supplemental injection system. The primary and supplemental injection systems may use the same type of fuel injection, or different types of fuel injection.

For example, the engine 18 is a spark ignition engine including a plurality of cylinders 60 that each receive an air-fuel mixture for combustion. Air may be received via an intake manifold 62, and controlled by a throttle or valve 64 that is controllable by the controller 40 to regulate airflow (represented by arrow A) into the intake manifold 62.

Each cylinder 60 is coupled to a spark plug 66, and an intake valve 68 for receiving air or an air-fuel mixture. Intake valve positions are regulated via an intake camshaft 70. An exhaust valve 72 is also coupled to each cylinder 60 for removing combustion exhaust (represented by arrow E).

An engine crankshaft (not shown) rotates at engine speed or a rate that is proportional to the engine speed. A crankshaft sensor 74 may be included to allow the controller 40 to determine the position of the crankshaft during engine operation.

The engine 18 includes a fuel system that has two fuel injection systems. The fuel injection systems are configured to supply fuel to the cylinders 60 using different injection techniques. The injection systems are in fluid communication with a fuel tank 76 and a high pressure pump 78.

In an embodiment, the fuel system includes a primary fuel injection system 80 and a supplemental fuel injection system 90. Each fuel injection system is configured to inject fuel using a different injection technique. For example, the fuel injection systems may use the same type of injection (e.g., direct injection or port injection) but have different parameters, such as different injector sizes allowing for different flow rates.

As shown in FIG. 2, the primary fuel injection system 80 is configured as a direct injection (DI) system, where fuel is injected directly into each cylinder 60 by a direct fuel injection technique. The supplemental fuel injection system 90 is configured as a port fuel injection (PFI) system, where fuel is injected via a PFI technique. The PFI technique, in this example, includes spraying fuel into the intake manifold 62 for mixing with air before an air-fuel mixture is delivered to each cylinder 60.

The primary fuel injection system 80 includes a primary fuel rail 82 in fluid communication with a direct injector 84 coupled to each cylinder 60. The primary fuel rail 82 is configured to flow pressurized fuel from the pump 78 to each direct injector 84. A primary fuel valve 86 is controllable by the controller 40 adjust the flow rate of fuel.

The supplemental fuel injection system 90 includes a supplemental fuel rail 92 configured to flow pressurized fuel from the pump 78 a port injector 94 associated with each cylinder 60. A supplemental fuel valve 96 is controllable by the controller 40 to adjust the flow rate of fuel through the fuel rail 92 (and/or to activate and deactivate the supplemental fuel injection system 90).

It is noted that the primary fuel valve 86 and the supplemental fuel valve 96 may be operated to adjust a relative amount of fuel provided by each injection system, and/or operated as a switch to activate or deactivate one of the injection systems. For example, the primary fuel valve 86 and/or the supplemental fuel valve 96 may be controlled to provide a ratio of a volume of fuel supplied by the supplemental fuel injection system 90 (a supplemental fuel volume) to a volume of fuel supplied by the primary fuel injection system 80 (a primary fuel volume).

The engine 18 can be operated according to a plurality of fuel injection modes. For example, the engine 18 can be operated in a normal mode, in which fuel injection is performed using an initial ratio of the supplemental fuel volume (e.g., injected by port fuel injection) to the primary fuel volume (e.g., injected by direct injection). This ratio is referred to an “injection ratio” and is defined as the ratio of a volume of fuel injected by the supplemental fuel injection system 90 during a stroke to a volume of fuel injected by the primary fuel injection system 80 during the stroke.

The normal mode may use only primary fuel injection (i.e., the ratio is zero), or a selected proportion of a total fuel volume injected by supplemental injection. For example, in the normal mode, the valve 96 is closed and the valve 86 is opened so that fuel is injected only via the primary fuel injection system 80. In another example, the normal mode uses an initial or first injection ratio, and the supplemental mode uses a second injection ratio that is different than the initial or first injection ratio.

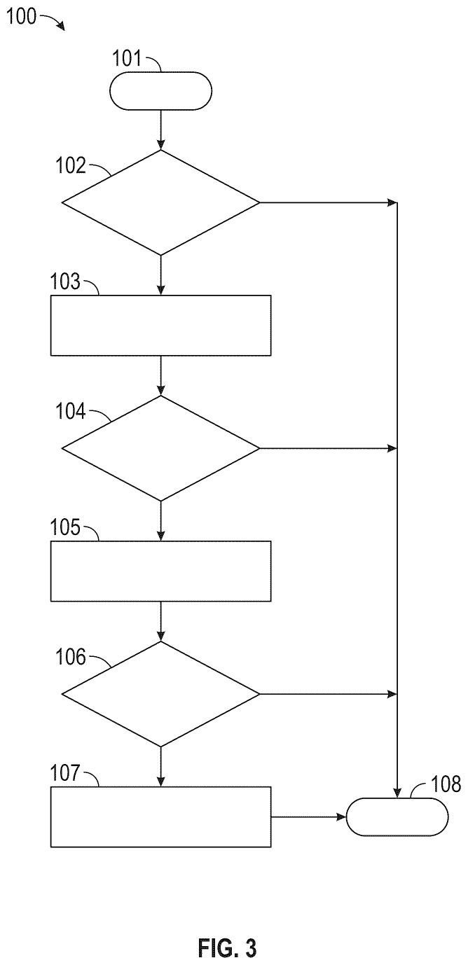

FIG. 3 illustrates embodiments of a method 100 of controlling a combustion engine. Aspects of the method 100 may be performed by the controller 40 or other suitable processing device.

The method 100 is described in conjunction with the engine 18 and fuel injection systems of FIG. 2 for illustrative purposes. Embodiments are not so limited, as the method 100 may be performed in conjunction with any suitable vehicle or drive system having dual injection capabilities.

The method 100 includes a number of steps or stages represented by blocks 101-108. The method 100 is not limited to the number or order of steps therein, as some steps represented by blocks 101-108 may be performed in a different order than that described below, or fewer than all of the steps may be performed.

At block 101, the vehicle 10 is in operation, and the engine 18 is running. At this point, the engine 18 is in a normal mode. In the normal mode, the supplemental fuel injection system 90 is inactive, and fuel injection is performed exclusively by the primary fuel injection system 80. Alternatively, in the normal mode, both injection systems are active, and are operated according to an initial injection ratio. The initial injection ratio is determined based on factors such as engine speed and load.

At block 102, the pump 78 (and/or other component of the engine 18 or fuel system) is monitored to determining whether a triggering condition is satisfied. For example, factors such as temperature changes, load changes and spark timing changes are monitored and compared to system limitations.

The controller 40 determines whether the factors are within system limitations. If the factors are within the system limitations, the method 100 ends at block 108 and fuel injection continues according to the normal mode. If the factors meet or exceed the system limitations, the triggering condition is satisfied and the method 100 proceeds to block 103.

At block 103, if the triggering condition is satisfied (i.e., a system or hardware limitation is met), a parameter related to fuel injection and/or engine operation is monitored, and the parameter is compared to a parameter threshold. The parameter may be related to the engine, such as rotational speed or torque. In an embodiment, the parameter is related to the flow of fuel to the engine 18.

Upon determination of the parameter, the parameter is compared to the parameter threshold. If the parameter does not meet or exceed the parameter threshold, the normal mode is maintained.

For example, the pump 78 is monitored to measure or estimate the volume demand of the pump 78 (i.e., volume of fuel being taken in) per stroke. The estimated volume demand is compared to a maximum volume capacity of the pump 78.

In an embodiment, an average of the volume demand is calculated over a plurality of strokes. This averaging is useful in situations where the number of lobes in the pump 78 does no match the number of cylinders 60.

At block 104, the controller 40 determines whether the parameter (e.g., estimated volume demand for a stroke or average volume demand) is still greater than or equal to the parameter threshold. If the parameter is no longer greater than or equal to the parameter threshold, the method 100 ends at block 108 and fuel injection continues according to the normal mode.

At block 105, if the parameter is still greater than or equal to the parameter threshold (e.g., volume demand still meets or exceeds the maximum volume capacity), the engine 18 is put into the supplemental mode, in which the ratio is adjusted (or primary fuel injection is disabled and supplemental fuel injection is enabled).

In an embodiment, the initial injection ratio is adjusted. For example, the average volume demand is used to calculate a new injection ratio. The initial ratio is adjusted by increasing the relative volume of fuel injected by the supplemental fuel injection system 90 to achieve the new injection ratio.

At block 106, the controller 40 determines whether the parameter continues to meet or exceed the parameter threshold while the new injection ratio is being applied. For example, the controller 40 continues with fuel injection using the new injection ratio, and measures the volume demand of the pump 78.

If the new injection ratio causes the volume demand (or other parameter) to be within the parameter threshold, the method 100 ends and fuel injection continues according to the new injection ratio.

At block 107, if the volume demand or other parameter still meets or exceeds the parameter threshold, the controller 40 causes airflow to be limited (e.g., by controlling the valve or throttle 64). The controller 40 continues to monitor the engine 18, and returns the airflow to the previous level if fuel demand drops to within the parameter threshold. If fuel demand drops further, the engine 18 may be returned to the normal mode.

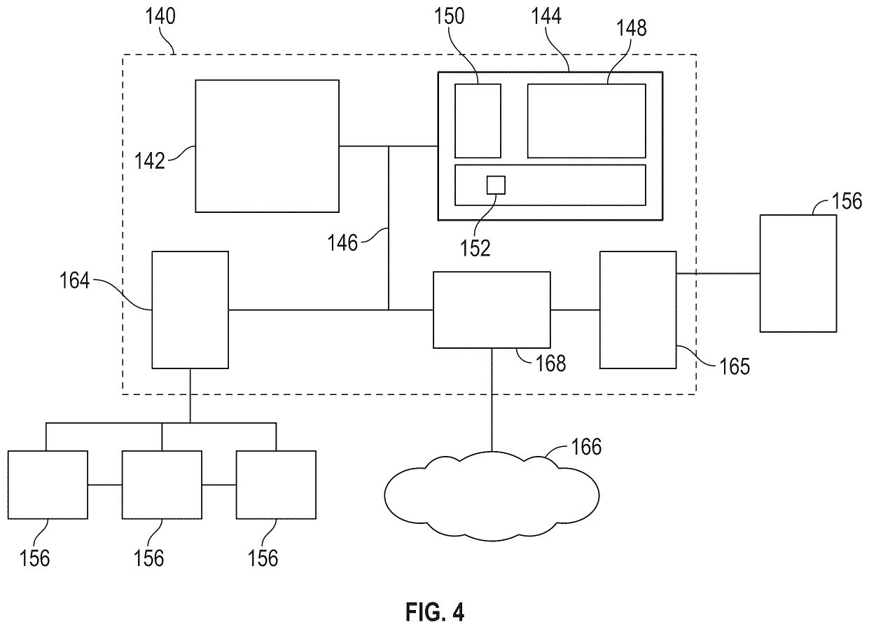

FIG. 4 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as read-only memory (ROM), and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for fuel injection, comprising:
a primary fuel injection system configured to inject a fuel into a cylinder of a combustion engine using a first injection technique;
a supplemental fuel injection system configured to inject the fuel into the cylinder according a second injection technique, the second injection technique being different than the first injection technique; and
a controller configured to monitor a parameter of a fuel pump connected to the primary fuel injection system and the supplemental fuel injection system, and based on the parameter being greater than or equal to a parameter threshold, control a ratio of a first volume of fuel injected by the supplemental fuel injection system to a second volume of fuel injected by the primary fuel injection system during an engine stroke.

2. The system of claim 1, wherein the primary fuel injection system includes a direct injector having a first size, and the supplemental fuel injection system includes a direct injector having a second size, the second size being different than the first size.

3. The system of claim 1, wherein the primary fuel injection system is a direct injection system, and the supplemental fuel injection system is a port fuel injection system.

4. The system of claim 1, wherein the parameter is a fuel intake volume related to an amount of the fuel that the fuel pump takes in.

5. The system of claim 1, wherein the parameter is an average volume of fuel intake to the fuel pump over a plurality of engine strokes.

6. The system of claim 1, wherein the controller is configured to operate the combustion engine according to a normal mode in which fuel injection is performed using a first value of the ratio, and operate the combustion engine according to a supplemental mode in which fuel injection is performed using a second value of the ratio, the second value of the ratio selected to cause the parameter to fall below the parameter threshold.

7. The system of claim 6, wherein the fuel injection is performed only by the primary fuel injection system in the normal mode, and the fuel injection is performed only by the supplemental fuel injection system or by a combination of the primary fuel injection system and the supplemental fuel injection system in the supplemental mode.

8. The system of claim 6, wherein the controller is configured to determine the parameter during the supplemental mode, and compare the determined parameter to the parameter threshold.

9. The system of claim 8, wherein the controller is configured to adjust a flow of air to the cylinder based on the determined parameter being greater than or equal to the parameter threshold during the supplemental mode.

10. A method of operating a combustion engine, comprising:
providing a fuel-air mixture to the combustion engine by injecting a fuel into a cylinder of the combustion engine, the injecting performed by at least one of a primary fuel injection system configured to inject the fuel using a first injection technique, and a supplemental fuel injection system configured to inject the fuel using a second injection technique, the second injection technique being different than the first injection technique;
monitoring a parameter of a fuel pump connected to the primary fuel injection system and the supplemental fuel injection system; and
based on the parameter being greater than or equal to a parameter threshold, controlling a ratio of a first volume of the fuel injected by the supplemental fuel injection system to a second volume of the fuel injected by the primary fuel injection system during an engine stroke.

11. The method of claim 10, wherein the primary fuel injection system includes a direct injector having a first size, and the supplemental fuel injection system includes a direct injector having a second size, the second size different than the first size.

12. The method of claim 10, wherein the primary fuel injection system is a direct injection system, and the supplemental fuel injection system is a port fuel injection system.

13. The method of claim 10, wherein the parameter is a fuel intake volume related to an amount of the fuel that the fuel pump takes in.

14. The method of claim 10, wherein the combustion engine is operated according to a normal mode in which fuel injection is performed using a first value of the ratio, and the combustion engine is operated according to a supplemental mode in which fuel injection is performed according to a second value of the ratio, the second value of the ratio selected to cause the parameter to fall below the parameter threshold.

15. The method of claim 14, wherein the fuel injection is performed only by the primary fuel injection system in the normal mode, and the fuel injection is performed only by the supplemental fuel injection system or by a combination of the primary fuel injection system and the supplemental fuel injection system in the supplemental mode.

16. The method of claim 14, further comprising determining the parameter during the supplemental mode, comparing the determined parameter to the parameter threshold, and adjusting a flow of air to the cylinder based on the determined parameter being greater than or equal to the parameter threshold.

17. A vehicle system comprising:
a combustion engine;
a fuel system including a primary fuel injection system configured to inject a fuel into a cylinder of the combustion engine using a first injection technique, and a supplemental fuel injection system configured to inject the fuel into the cylinder using a second injection technique, the second injection technique being different than the first injection technique; and
a controller configured to monitor a parameter of a fuel pump connected to the primary fuel injection system and the supplemental fuel injection system, and based on the parameter being greater than or equal to a parameter threshold, control a ratio of a first volume of the fuel injected by the supplemental fuel injection system to a second volume of the fuel injected by the primary fuel injection system during an engine stroke.

18. The vehicle system of claim 17, wherein the controller is configured to operate the combustion engine according to a normal mode in which fuel injection is performed using a first value of the ratio, and operate the combustion engine according to a supplemental mode in which fuel injection is performed using a second value of the ratio, the second value of the ratio selected to cause the parameter to fall below the parameter threshold.

19. The vehicle system of claim 18, wherein the fuel injection is performed only by the primary fuel injection system in the normal mode, and the fuel injection is performed only by the supplemental fuel injection system or by a combination of the primary fuel injection system and the supplemental fuel injection system in the supplemental mode.

20. The vehicle system of claim 18, wherein the controller is configured to determine the parameter during the supplemental mode, compare the determined parameter to the parameter threshold, and adjust a flow of air to the cylinder based on the determined parameter being greater than or equal to the parameter threshold.
